(19) United States
(12) Patent Application Publication
(10) Pub. No.: US 2013/0257890 A1
(43) Pub. Date: Oct. 3, 2013

(54) COLOR ADJUSTMENT DEVICE, COLOR ADJUSTMENT SYSTEM, COLOR ADJUSTMENT METHOD, AND NON-TRANSITORY COMPUTER-READABLE MEDIUM

(71) Applicants: Noriko SAKAI, Kanagawa (JP); Toshihiro IWAFUCHI, Kanagawa (JP); Kazuhiko HORIKAWA, Kanagawa (JP)

(72) Inventors: Noriko SAKAI, Kanagawa (JP); Toshihiro IWAFUCHI, Kanagawa (JP); Kazuhiko HORIKAWA, Kanagawa (JP)

(73) Assignee: FUJI XEROX CO., LTD., Tokyo (JP)

(21) Appl. No.: 13/596,958

(22) Filed: Aug. 28, 2012

(30) Foreign Application Priority Data
Mar. 27, 2012 (JP) 2012-072255

(51) Int. Cl. G09G 5/02

(52) U.S. Cl. 345/589

(57) ABSTRACT

A color adjustment device includes a color-value obtaining unit, a color-property-value deriving unit, a correction-item selection unit, a target-property-value setting unit, a correction-coefficient deriving unit, and a color-adjustment-profile generating unit. The color-value obtaining unit obtains color values when an image is displayed on image display devices. The color-property-value deriving unit derives values of color properties from the color values. The correction-item selection unit selects a color property as a correction item on the basis of the derived values. The target-property-value setting unit sets a target property value for the correction item. The correction-coefficient deriving unit derives a correction coefficient to be used to correct the values of the color property to the target property value. The color-adjustment-profile generating unit generates a color-adjustment profile on the basis of the correction coefficient.

### CROSS-REFERENCE TO RELATED APPLICATIONS

This application is based on and claims priority under 35 USC 119 from Japanese Patent Application No. 2012-072255 filed Mar. 27, 2012.

### BACKGROUND

1. Technical Field

The present invention relates to a color adjustment device, a color adjustment system, a color adjustment method, and a non-transitory computer-readable medium.

2. Summary

According to an aspect of the invention, there is provided a color adjustment device including a color-value obtaining unit, a color-property-value deriving unit, a correction-item selection unit, a target-property-value setting unit, a correction-coefficient deriving unit, and a color-adjustment-profile generating unit. The color-value obtaining unit obtains color values in a case where an image which is determined in advance is displayed on image display devices that are obtainment targets which display images. The color-property-value deriving unit derives, from the color values obtained by the color-value obtaining unit, values of color properties of the image display devices that are obtainment targets. The color properties are properties associated with color expressions and determined in advance. The correction-item selection unit selects a color property as a common correction item from among the color properties on the basis of the values of the color properties derived by the color-property-value deriving unit. The correction item is an item that is to be used to perform color adjustment for an image which is to be displayed on an image display device that is an adjustment target. The target-property-value setting unit sets, for the correction item selected by the correction-item selection unit, a target property value which is to be used as a common target in the case where color adjustment is performed for an image that is to be displayed on the image display device that is an adjustment target and which is a value of the color property selected as the correction item. The correction-coefficient deriving unit derives a common correction coefficient which is to be used to correct the values of the color property selected as the correction item to the target property value that has been set by the target-property-value setting unit. The color-adjustment-profile generating unit generates, on the basis of the correction coefficient derived by the correction-coefficient deriving unit, a color-adjustment profile which is to be used to convert an input image signal in order to perform color adjustment for an image which is to be displayed on the image display device that is an adjustment target.

### BRIEF DESCRIPTION OF THE DRAWINGS

Exemplary embodiments of the present invention will be described in detail based on the following figures, wherein:

FIG. 1 is a diagram illustrating an example of an overall configuration of a color adjustment system according to a present exemplary embodiment;

FIG. 2 is a diagram illustrating a hardware configuration of a terminal apparatus;

FIGS. 3A and 3B are diagrams for explaining examples of a functional configuration of a color adjustment device in the present exemplary embodiment;

FIG. 4 is a diagram for explaining an example of a functional configuration of a first-color-conversion-profile generating section;

FIG. 5 is a flowchart for explaining an example of an operation of the first-color-conversion-profile generating section;

FIG. 6 is a diagram for explaining a procedure, which is performed by a target-property-value setting unit, for setting a target property value for black brightness in the case where the black brightness is selected as a correction item by a correction-item selection unit;

FIG. 7 is a diagram for explaining a procedure, which is performed by the target-property-value setting unit, for setting a target property value for color temperature in the case where the color temperature is selected as a correction item by the correction-item selection unit;

FIG. 8 is a diagram illustrating examples of upper and lower limit values of the color temperature that are values which can be set for each monitor;

FIG. 9 is a diagram for explaining a procedure, which is performed by the target-property-value setting unit, for setting a target property value for the shape of a color gamut in the case where the shape of the color gamut is selected as a correction item by the correction-item selection unit; and

FIG. 10 is a diagram for explaining another example of the functional configuration of the color adjustment device in the present exemplary embodiment.

### DETAILED DESCRIPTION

Hereinafter, exemplary embodiments of the present invention will be described in detail with reference to the accompanying drawings.

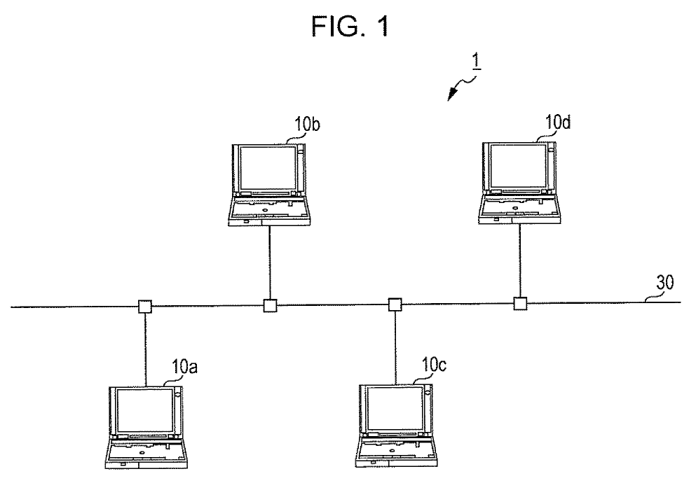

FIG. 1 is a diagram illustrating an example of an overall configuration of a color adjustment system 1 according to a present exemplary embodiment.

Here, the color adjustment system 1 illustrated in FIG. 1 includes terminal apparatuses 10a, 10b, 10c, and 10d, and a network 30 that is connected to the terminal apparatuses 10a to 10d. Note that, in the description given below, when it is not necessary to distinguish the terminal apparatuses 10a to 10d from one another, the terminal apparatuses 10a to 10d are referred to as “terminal apparatuses 10”. Furthermore, although only four terminal apparatuses 10 are illustrated in FIG. 1, five or more terminal apparatuses 10 may be provided.

Although the details of each of the terminal apparatuses 10 are described below, the terminal apparatus 10 is a computer apparatus having a monitor that displays an image which is determined in advance. Here, examples of the terminal apparatus 10 may include a personal computer (PC).

The network 30 is a communication medium that is used for information communication among the terminal apparatuses 10, and is, for example, a local area network (LAN). Note that, in the present exemplary embodiment, the network 30 is not necessarily necessary, and each of the terminal apparatuses 10a to 10d may be a so-called standalone apparatus.

Next, a hardware configuration of each of the terminal apparatuses 10 will be described.

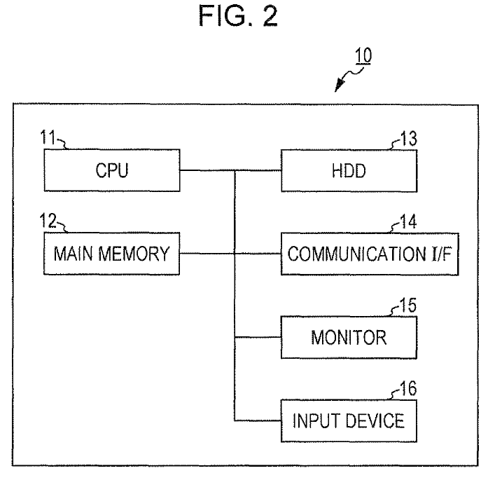

FIG. 2 is a diagram illustrating the hardware configuration of the terminal apparatus 10.

As illustrated in FIG. 2, the terminal apparatus 10 includes a central processing unit (CPU) that is a computing unit, a main memory 12 that is a memory, and a hard disk drive (HDD) 13. Here, the CPU 11 executes various types of software such as an operating system (OS) and applications. Furthermore, the main memory 12 is used as a storage region in which the various types of software, data used to execute the various types of software, and so forth are stored. The HDD 13 is used as a storage region in which input data that is to be input to the various types of software, output data that is output from the various types of software, and so forth are stored.

The terminal apparatus 10 further includes a communication interface (I/F) 14, a monitor 15, and an input device 16. The communication I/F 14 is used to perform communication with the outside. The monitor 15 includes a video memory, a display, and so forth, and is an example of an image display device that displays an image. The input device 16 is a key board, a mouse, or the like. Note that, here, examples of the monitor 15 include not only a liquid crystal monitor and a cathode-ray tube monitor which are used for PCs, but also a projector, and a liquid crystal display and a plasma display which are used for television sets. Additionally, regarding the monitor 15, the number of monitors 15 for one terminal apparatus 10 is not limited to one, and multiple monitors 15 may be provided for one terminal apparatus 10.

Here, in a case of displaying an image on the monitors 15, it is desirable that the image be displayed with the same color expression on all of the individual monitors 15 of the terminal apparatuses 10. Typically, for example, in a case in which an input image signal is converted into a color signal of an sRGB color space and in which elements that support the sRGB color space are used in each of the monitors 15, regarding the color expressions of the individual monitors 15, the color expressions with which an image is displayed on the individual monitors 15 tend to be the same.

However, even when the same sRGB input image signal is input to the individual monitors 15, the color expressions with which an image is displayed on the individual monitors 15 are not the same in reality because the color properties, which are properties associated with color expressions, of the monitors 15 are different from one another. The color properties differ depending on the manufacturers or model numbers of the monitors 15. Furthermore, even when the monitors 15 are monitors that were produced by the same manufacturer and that have the same model number, typically, the color properties of the monitors 15 also differ depending on variations that occur at the time of production or changes that occur over time.

Accordingly, in the present exemplary embodiment, a color adjustment device 100 that is built into each of the terminal apparatuses 10 is provided. By using the color adjustment device 100, a color property is selected as a more useful correction item from among color properties that are determined in advance. A target property value that is common to the individual monitors 15 is set for the selected correction item, and an input image signal is corrected, whereby substantially the same color expression can be obtained.

Hereinafter, the above-mentioned items will be described in further detail.

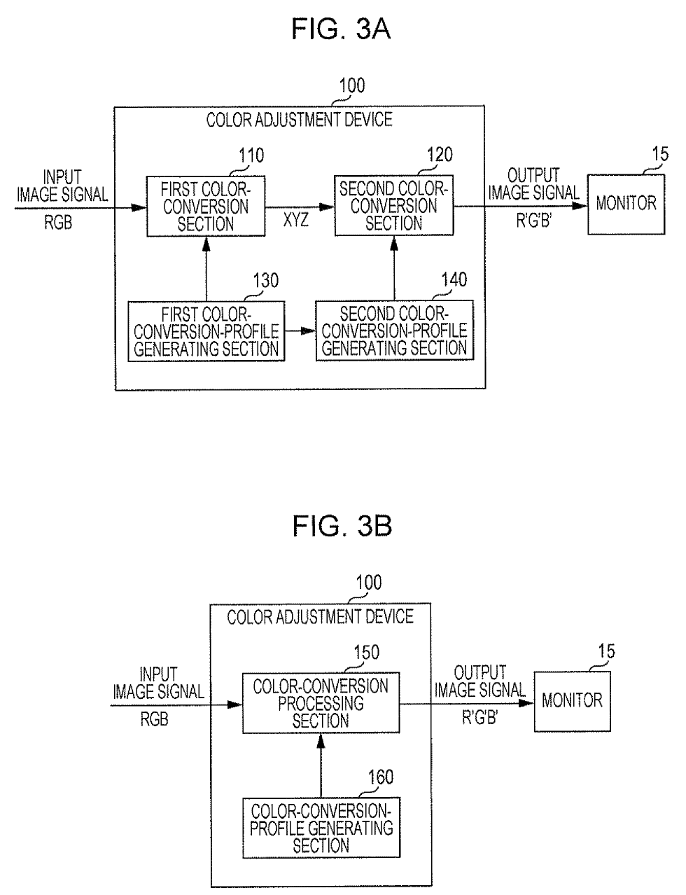

FIGS. 3A and 3B are diagrams for explaining examples of a functional configuration of the color adjustment device 100 in the present exemplary embodiment.

The color adjustment device 100 illustrated in FIG. 3A includes a first-color-conversion section 110, a second-color-conversion section 120, a first-color-conversion-profile generating section 130, and a second-color-conversion-profile generating section 140. The first-color-conversion section 110 is an example of a color conversion section that converts, using a first color-conversion profile (a color-adjustment profile), an input image signal. Note that, here, although the monitor 15 is not included in the color adjustment device 100 in the present exemplary embodiment, the monitor 15 that displays an image using an output image signal is illustrated together.

The first-color-conversion section 110 performs first color conversion on an input image signal. Here, for a correction item that is selected as an item which is common to the individual monitors 15, the first-color-conversion section 110 corrects an input image signal using the first color-conversion profile. The first color-conversion profile is used to correct values of a color property of the individual monitors 15 to a common target. In other words, even for each of the individual monitors 15 that are different from one another, the first-color-conversion section 110 corrects a corresponding input image signal to a common color signal. Note that, here, an RGB color signal of an RGB color system is converted into an XYZ color signal of an XYZ color system. Alternatively, an RGB color signal that is input may be converted by the first-color-conversion section 110 into an sRGB color signal as a color signal of a typical RGB color space, and, then, the sRGB color signal may be converted into an XYZ color signal.

The second-color-conversion section 120 performs second color conversion, thereby converting, using a second color-conversion profile that is determined in advance, an input color signal, which has been obtained by conversion performed by the first-color-conversion section 110, into an output image signal. For the color properties other than the color property for which correction has been performed by the first-color-conversion section 110, the second-color-conversion section 120 performs correction that is suitable for each of the monitors 15. In other words, the second-color-conversion section 120 performs different correction for each of the monitors 15. Accordingly, each of the monitors 15 has a different second color-conversion profile. The second-color-conversion section 120 performs correction for the color properties of each of the monitors 15. Note that, here, the XYZ color signal is converted into an RGB color signal, and the RGB color signal is output as an output image signal.

In other words, in the present exemplary embodiment, a color property that easily influences the color expressions of the monitors 15 is selected as a common correction item. Then, first, common color conversion is performed by the first-color-conversion section 110 for the selected correction item. Then, color conversion that is suitable for each of the monitors 15 is performed by the second-color-conversion section 120 for the other color properties. As illustrated in FIG. 3A, each of the monitors 15 displays an image using an output image signal that has been obtained by conversion performed by the color adjustment device 100.

The first-color-conversion-profile generating section 130 generates the first color-conversion profile that is to be used by the first-color-conversion section 110. The first-color-conversion-profile generating section 130 will be described below in further detail.

The second-color-conversion-profile generating section 140 generates the second color-conversion profile that is to be used by the second-color-conversion section 120.

Note that, as illustrated in FIG. 3B, one color-conversion processing section 150 into which the first-color-conversion section 110 and the second-color-conversion section 120 illustrated in FIG. 3A are integrated may be provided. In this case, an input image signal is directly converted, using a color-conversion profile generated by a color-conversion-profile generating section 160, into an output image signal by the color-conversion processing section 150.

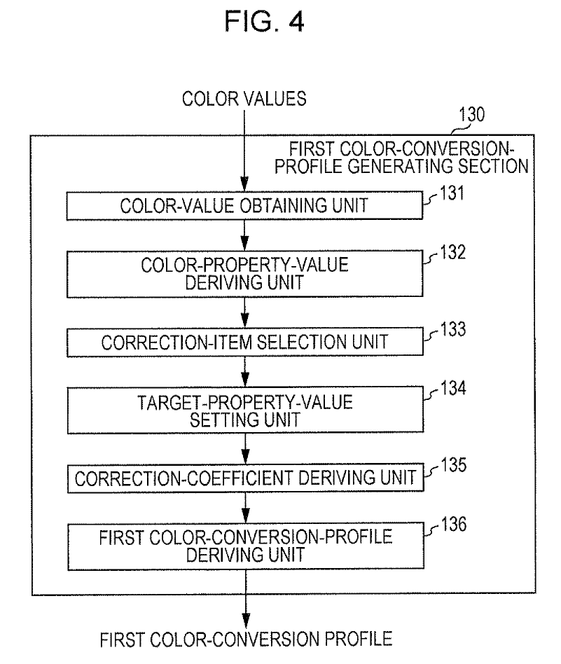

FIG. 4 is a diagram for explaining an example of a functional configuration of the first-color-conversion-profile generating section 130.

As illustrated in FIG. 4, the first-color-conversion-profile generating section 130 includes a color-value obtaining unit 131, a color-property-value deriving unit 132, a correction-item selection unit 133, a target-property-value setting unit 134, a correction-coefficient deriving unit 135, and a first-color-conversion-profile deriving unit 136.

The color-value obtaining unit 131 obtains, from the multiple monitors 15, color values in the case where an image determined in advance is displayed on the monitors 15. In the present exemplary embodiment, the color-value obtaining unit 131 obtains, as color values in the case where an image determined in advance is displayed, the following values: color values in the case where a white image is displayed on the monitors 15; color values in the case where a black image is displayed on the monitors 15; and color values of primary colors in the case where the primary colors are displayed on the monitors 15.

More specifically, an administrator who manages the color adjustment system 1 measures the color values with a measurement device that is determined in advance, and inputs the color values, using the input device 16 or the like, to the color adjustment device 100. Note that, here, the primary colors are colors that are used to display an image on the monitors 15, and, typically, are three colors, i.e., red (R), green (G), and blue (B). The color-value obtaining unit 131 obtains, as the color values of the primary colors, color values in the case where R, G, and B, are made to be the saturated colors thereof by changing the tone values of R, G, and B.

The color-property-value deriving unit 132 derives, from the color values obtained by the color-value obtaining unit 131, values of color properties, which are determined in advance, of the monitors 15.

Here, although the details of the color properties that are determined in advance will be described below, the color properties are, for example, the following: brightness (black brightness) in the case where a black image is displayed on the monitors 15; color temperature in the case where a white image is displayed on the monitors 15; and the shape of a color gamut of each of the monitors 15. The values of the color properties can be derived using the above-described color values and calculation formulas that are determined in advance.

The correction-item selection unit 133 selects a color property as a common correction item from among the color properties on the basis of the values of the color properties derived by the color-property-value deriving unit 132. The common correction item is to be used to perform color adjustment for an image which is to be displayed on each of the monitors 15.

Although the details of the correction item will be described below, for example, a color property, variations in the values of the color property of the monitors 15 being large, is selected as the correction item from among the black brightness, the color temperature, and the shape of the color gamut. Accordingly, regarding all of the three color properties, each of the three color properties may be selected as the correction item. Alternatively, only one color property may be selected.

The target-property-value setting unit 134 sets, for the correction item selected by the correction-item selection unit 133, a target property value that is to be used as a common target in the case where color adjustment is performed for an image that is to be displayed on each of the monitors 15 and that is a value of the color property selected as the correction item.

In other words, here, for the color property selected as the correction item from among the color properties, a common target value to which the values of the color property are to be corrected is set.

The correction-coefficient deriving unit 135 derives a common correction coefficient that is to be used to correct the values of the color property, which has been selected as the correction item, to the target property value which has been set by the target-property-value setting unit 134.

In other words, for a color property that is at least one of the black brightness, the color temperature, and the shape of the color gamut, which are described above, a correction coefficient that is to be used to correct values of the color property to the target property value is derived.

The first-color-conversion-profile deriving unit 136 is an example of a color-adjustment-profile generating unit. The first-color-conversion-profile deriving unit 136 generates a color-adjustment profile on the basis of the correction coefficient derived by the correction-coefficient deriving unit 135. The color-adjustment profile is to be used to convert an input image signal in order to perform color adjustment for each of the monitors 15. Here, the color-adjustment profile is the first color-conversion profile, and, in the example illustrated in FIG. 3A, is to be used by the first-color-conversion section 110 to convert an input image signal. More specifically, the first color-conversion profile is, for example, in a form such as a direct look up table (DLUT), which is a multi-dimensional table, a matrix, or a one-dimensional look up table (LUT).

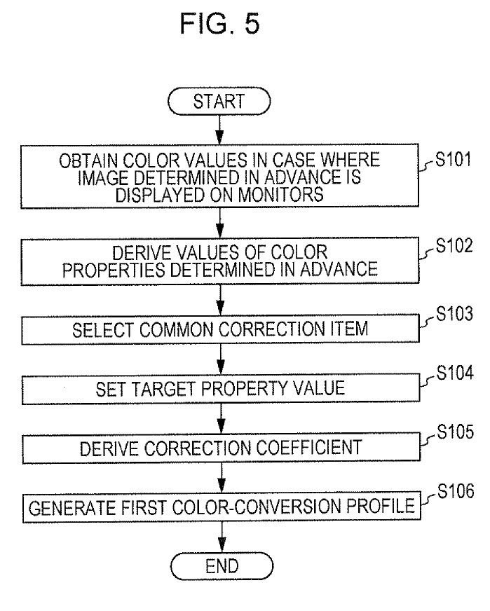

FIG. 5 is a flowchart for explaining an example of an operation of the first-color-conversion-profile generating section 130.

Hereinafter, the operation of the first-color-conversion-profile generating section 130 will be described using FIGS. 4 and 5.

First, the color-value obtaining unit 131 obtains, from the multiple monitors 15, color values in the case where an image determined in advance is displayed on the monitors 15 (step S101). Here, the obtained color values are color values in the case where a white image is displayed on the monitors 15, color values in the case where a black image is displayed on the monitors 15, and color values in the case where the saturated colors of R, G, and B, which are the primary colors, are displayed on the monitors 15. In the present exemplary embodiment, for example, the administrator who manages the color adjustment system 1 inputs, to the color adjustment device 100, L*-values, a*-values, and b*-values of an L*a*b* color system or X-values, Y-values, and Z-values of the XYZ color system, whereby the color values are obtained by the color-value obtaining unit 131.

Next, the color-property-value deriving unit 132 derives, from the color values obtained by the color-value obtaining unit 131, as values of color properties determined in advance, the following: values of the brightness (black brightness) in the case where a black image is displayed on the monitors 15; values of the color temperature in the case where a white image is displayed on the monitors 15; and values of the shape of a color gamut of each of the monitors 15 (step S102).

Here, a value of the black brightness is an L*-value or a Y-value in the case where a black image is displayed. Furthermore, a value of the color temperature in the case where a white image is displayed can be derived from an X-value, a Y-value, and a Z-value obtained for the white image. Moreover, a value of the shape of the color gamut can be derived from an a*-value and a b*-value or an X-value, a Y-value, and a Z-value in the case where the saturated colors of R, G, and B are displayed.

Next, the correction-item selection unit 133 selects a color property as a common correction item from among the color properties on the basis of the values of the color properties derived by the color-property-value deriving unit 132. The common correction item is to be used to perform color adjustment for an image which is to be displayed on each of the monitors 15 (step S103).

Here, the values of the black brightness, the color temperature, and the shape of the color gamut, which have been derived as values of the color properties, of the individual monitors 15 are compared with one another. When variations in the values of a color property of the monitors 15 are larger than a value that is determined in advance, the color property is selected as a correction item. Note that, when variations in the values of a color property of the monitors 15 are equal to or smaller than the value that is determined in advance, the color property is not selected.

Then, the target-property-value setting unit 134 sets, for the correction item selected by the correction-item selection unit 133, a target property value that is to be used as a common target in the case where color adjustment is performed for an image which is to be displayed on each of the monitors 15 and that is a value of the color property selected as the correction item (step S104). Although setting of a target property value will be described in detail, a target property value may be calculated using a method that is determined in advance, and be set. Alternatively, the administrator may input a target property value, and the target property value that has been input may be set.

The correction-coefficient deriving unit 135 derives a correction coefficient that is to be used to correct the values of the color property, which has been selected as the correction item, to the target property value which has been set by the target-property-value setting unit 134 (step S105). The correction coefficient is also common to the individual monitors 15. Note that steps S104 and S105 will be described below in detail.

Finally, the first-color-conversion-profile deriving unit 136 generates, on the basis of the correction coefficient derived by the correction-coefficient deriving unit 135, the first color-conversion profile that is a color-adjustment profile which is to be used to convert an input image signal in order to perform color adjustment for each of the monitors 15 (step S106).

The first color-conversion profile is to be used by the first-color-conversion section 110 to convert an input image signal. For example, an RGB color signal is converted into an XYZ color signal.

As described above, in the present exemplary embodiment, the black brightness, the color temperature, and the shape of the color gamut are selected from among various color properties that are to be used to perform color adjustment for each of the monitors 15. Among the black brightness, the color temperature, and the shape of the color gamut, a color property, variations in the values of the color property being large, is selected as a correction item, and a common correction coefficient is generated for the correction item. First color conversion is performed by the first-color-conversion section 110 using the common first color-conversion profile that has been generated on the basis of the correction coefficient. The reason why the three color properties have been selected is that the three color properties easily influence the color expressions of the monitors 15. The values of each of the three color properties are made the same using the common first color-conversion profile, whereby the color expressions of the monitors 15 can be substantially adjusted first.

Furthermore, in this case, the color properties of each of the monitors 15 on an output side can be reflected in an input image signal on an input side. Accordingly, at a point in time when the input image signal passes through the first-color-conversion section 110, substantially the same color expression can be obtained using the input image signal for each of the monitors 15. Note that color properties which are different from the above-described three color properties are used in further fine adjustment, and the further fine adjustment is performed by performing second conversion with the second-color-conversion section 120 using the second color-conversion profile that is a file different for each of the monitors 15. Because color adjustment is performed in two steps in this manner, even when the differences among the values of a color property of the individual monitors 15 are originally large, color adjustment with a higher accuracy can easily be performed. Thus, the color expressions of the individual monitors 15 are easily made substantially the same. Note that, when the differences among the values of a color property of the individual monitors 15 are originally not so large, for example, in the case where the individual monitors 15 are monitors that were produced by the same manufacturer and that have the same model number, the second-color-conversion section 120 and the second color-conversion profile are not necessarily necessary. Note that the second color-conversion profile is used by the second color-conversion section 120 to perform color conversion so as to correct, for example, the following color properties: brightness in the case where a white image is displayed on the monitors 15; tint (saturation or hue) in the case where a black image is displayed on the monitors 15; and the hue angles of the primary colors.

Next, the processes of steps S104 and S105 illustrated in FIG. 5 will be described in further detail.

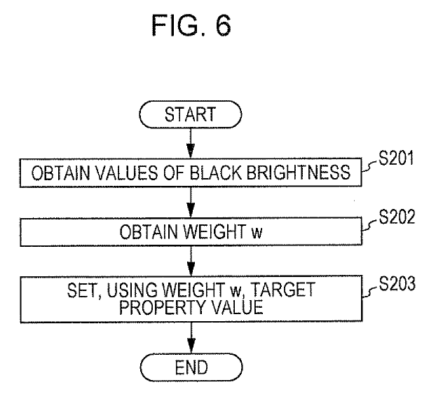

FIG. 6 is a diagram for explaining a procedure, which is performed by the target-property-value setting unit 134, for setting a target property value for the black brightness in the case where the black brightness is selected as a correction item by the correction-item selection unit 133. In other words, an operation performed for the black brightness in step S104 is described with reference to FIG. 6.

First, the target-property-value setting unit 134 obtains values of the black brightness of the individual monitors 15 (step S201). Then, the target-property-value setting unit 134 sets, using the values of the black brightness of the individual monitors 15, the target property value for the black brightness. In order to set the target property value, the individual values of the black brightness may be simply averaged. However, in the present exemplary embodiment, a value that is obtained by performing weighting in which the frequencies of use of the monitors 15 are reflected is set as the target property value.

In this case, first, the target-property-value setting unit 134 obtains a weight w that is a parameter for the frequency of use of each of the monitors 15 (step S202), and sets, using the weight w, the target property value (step S203). Regarding the weight w, for example, the administrator of the color adjustment system 1 inputs the weight w, and the target-property-value setting unit 134 obtains the weight w that has been input.

More specifically, it is supposed that there are monitors 15 and the number of monitors 15 is n. The value of the black brightness of each of the monitors 15 is denoted by Yₖ, and the weight of the monitor 15 is denoted by wₖ (wherein k=1, 2, 3, . . . , n). The target property value for the black brightness in this case can be calculated using Equation (1) given below.

(the target property value for the black brightness)=Σ(Yₖ×wₖ)/Σwₖ (k=1, 2, 3, . . . , n) (1)

In the present exemplary embodiment, the correction coefficient that is calculated by the correction-coefficient deriving unit 135 in step S105 is, in the case of changing the black brightness as in the present exemplary embodiment, a correction coefficient for a brightness value (for example, an L*-value or a Y-value) obtained for an input image signal. Here, for example, the correction coefficient is set so that the correction amount increases with decreasing brightness value, and the correction amount decreases with increasing brightness value. In other words, for the value of the black brightness that becomes a minimum brightness value which corresponds to the case where black is displayed, the correction coefficient is set so that the value of the black brightness will be corrected to the target property value. In contrast, correction is not performed for a maximum brightness value that corresponds to the case where white is displayed. When the brightness value is larger than the minimum brightness value and smaller than the maximum brightness value, the smaller the brightness value is and the closer to black the color is, the larger the correction amount is, and the larger the brightness value is and the closer to white the color is, the smaller the correction amount is.

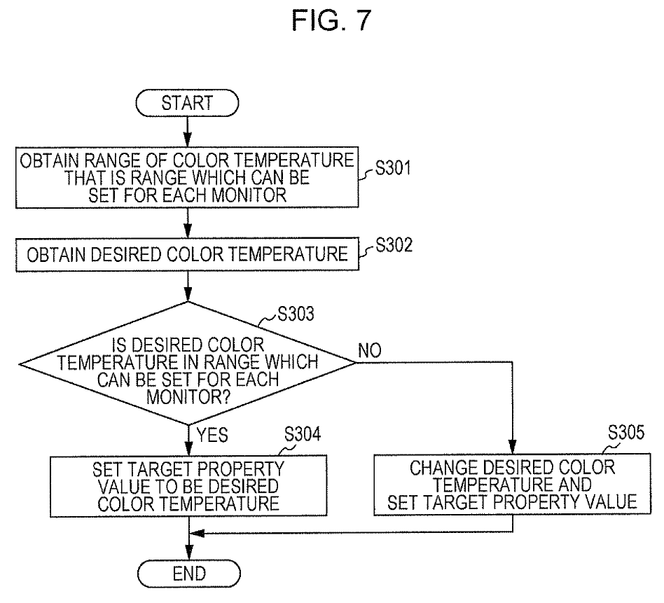

FIG. 7 is a diagram for explaining a procedure, which is performed by the target-property-value setting unit 134, for setting a target property value for the color temperature in the case where the color temperature is selected as a correction item by the correction-item selection unit 133. In other words, an operation performed for the color temperature in step S104 is described with reference to FIG. 7.

First, the target-property-value setting unit 134 obtains a range of the color temperature that is a range which can be set for each of the monitors 15 (step S301). Practically, the target-property-value setting unit 134 obtains the upper and lower limit values of the color temperature that are values which can be set for each of the monitors 15. Regarding the upper and lower limit values of the color temperature that are values which can be set, for example, the administrator of the color adjustment system 1 refers to the setting menu, the specification, or the like of the monitors 15, thereby obtaining the upper and lower limit values as reference results. Then, the administrator inputs the reference results that are the upper and lower limit values, and the target-property-value setting unit 134 obtains the upper and lower limit values that have been input.

Selection of a value from the range of the color temperature that is a range which can be set for each of the monitors 15 and setting of the selected value as the target property value for the color temperature are performed, for example, in the following manner.

When the administrator inputs the upper and lower limit values of the color temperature that are values which can be set, the administrator also inputs a desired color temperature, and the target-property-value setting unit 134 obtains the desired color temperature (step S302). Next, the target-property-value setting unit 134 determines whether or not the desired color temperature is within a range between the upper and lower limit values that is the range of the color temperature which can be set for each of the monitors 15 (step S303). When the desired color temperature is within the range (YES in step S303), the target-property-value setting unit 134 sets the target property value to be the desired color temperature (step S304). In contrast, when the desired color temperature is outside the range (NO in step S303), the target-property-value setting unit 134 changes the desired color temperature, and sets the target property value (step S305).

Here, the processes of steps S303 to S305 are performed, more specifically, in the following manner.

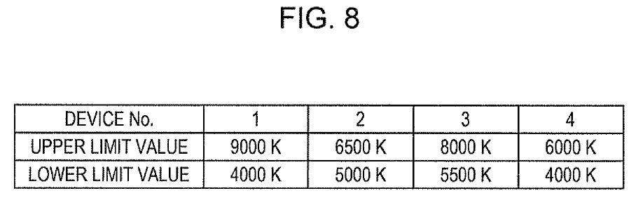

FIG. 8 is a diagram illustrating examples of the upper and lower limit values of the color temperature that are values which can be set for each of the monitors 15.

As illustrated in FIG. 8, here, it is supposed that there are four monitors 15 to which 1 to 4 are assigned as “device No.”. The upper and lower limit values of the color temperature of the four monitors 15 are illustrated as absolute temperatures. The monitors 15 to which 1, 2, 3, and 4 are assigned as “device No.” correspond to, for example, the individual monitors 15 included in the terminal apparatuses 10a, 10b, 10c, and 10d, respectively.

In the case where the desired color temperature is 6000 K, 6000 K is a color temperature that can be set for all of the four monitors 15. Accordingly, the target-property-value setting unit 134 sets the target property value to be 6000 K. In the case where the desired color temperature is 4500 K, the desired color temperature is much lower than each of the lower limit values of the color temperature which are values that can be set for the monitors 15 to which “device No. 2” and “device No. 3” are assigned. The difference between the desired color temperature and the lower limit value of the color temperature of the monitor 15 to which “device No. 3” is assigned is 1000 K, and is larger than 500 K that is the difference between the desired color temperature and the lower limit value of the color temperature of the monitor 15 to which “device No. 2” is assigned. In this case, the target-property-value setting unit 134 sets the target property value for the color temperature so that the difference between the target property value and the lower limit value of the range that can be set for the monitor 15 to which “device No. 3” is assigned is within a range which is determined in advance. In this case, for example, the target-property-value setting unit 134 sets the target property value for the color temperature to be 5000 K that is 500 K lower than 5500 K. In this manner, when the desired color temperature is outside each of the ranges of the color temperature that are ranges which can be set for the individual monitors 15, a monitor 15, the difference between the upper or lower limit value of the range of the color temperature and the desired color temperature being largest, is selected among the monitors 15. Then, the target-property-value setting unit 134 sets, as the target property value, a color temperature that is within the range from the upper limit value, which can be set for the monitor 15, to a value that is 500 K larger than the upper limit value or within the range from the lower limit value, which can be set for the monitor 15, to a value which is 500 K smaller than the lower limit value.

Note that, even when the target property value for the color temperature is set to be outside the range, which can be set using a menu or the like of the monitors 15, of the color temperature, outputs of R, G, and B of each of the monitors 15 are changed, whereby it is normally possible to display an image with a color temperature that is set as the target property value. In other words, in the case where it is desired to reduce the color temperature, it is necessary to change the colors of an image so that redness is increased. By changing the gradients of the tone curves of B and R so that the gradient of the tone curve of B is lower than the gradient of the tone curve of R, R is made relatively stronger than B, whereby an increase in redness can be realized. In contrast, in the case where it is desired to increase the color temperature, it is necessary to change the colors of an image so that blueness is increased. By changing the gradients of the tone curves of B and R so that the gradient of the tone curve of R is lower than the gradient of the tone curve of B, B is made relatively stronger than R, whereby an increase in blueness can be realized. However, in the case where the target property value is far larger than the upper limit value or far smaller than the lower limit value, the balance among R, G, and B is lost, and, consequently, for example, a problem that it is difficult to perform display with tones occurs. Thus, as described above, the target property value is set so as to be within a range that ranges from the upper or lower limit value and that is determined in advance.

Note that, in the present exemplary embodiment, the correction coefficient which is calculated by the correction-coefficient deriving unit 135 in step S105 is, for example, a color correction coefficient for an input image signal. More specifically, in the case where the color temperature is changed as in the present exemplary embodiment, the correction coefficient is, for example, a correction coefficient that is to be used to correct an a*-value and a b*-value or an X-value, a Y-value, and a Z-value.

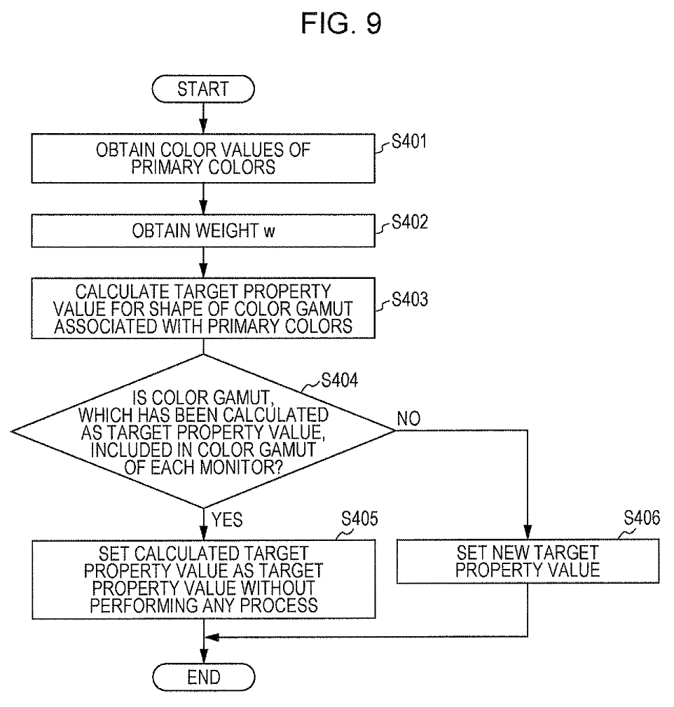

FIG. 9 is a diagram for explaining a procedure, which is performed by the target-property-value setting unit 134, for setting a target property value for the shape of the color gamut in the case where the shape of the color gamut is selected as a correction item by the correction-item selection unit 133. In other words, an operation performed for the shape of the color gamut in step S104 is described with reference to FIG. 9.

First, the target-property-value setting unit 134 obtains color values in the case where the saturated colors of R, G, and B, which are the primary colors, are displayed on the individual monitors 15 (step S401). Here, for example, the target-property-value setting unit 134 obtains color values as a*-values and b*-values in the case where the saturated colors of R, G, and B are displayed. Then, a target property value for the shape of the color gamut is set using the a*-values and the b*-values, for example, in the following manner.

In order to set the target property value for the shape of the color gamut, the a*-values and the b*-values in the case where the saturated colors of R, G, and B are displayed on the individual monitors 15 may be simply averaged. However, in the present exemplary embodiment, as in the case described with reference to FIG. 6, a value that is obtained by performing weighting in which the frequencies of use of the monitors 15 are reflected is set as the target property value.

In this case, first, the target-property-value setting unit 134 obtains the weight w that is a parameter for the frequency of use of each of the monitors 15 (step S402), and calculates, using the weight w, the target property value for the shape of the color gamut (step S403). The shape of the color gamut that is obtained in this manner is used as the target property value. Regarding the weight w, for example, the administrator of the color adjustment system 1 inputs the weight w, as in the case described with reference to FIG. 6.

Then, for the shape of the color gamut calculated as the target property value, the target-property-value setting unit 134 determines whether or not the color gamut is included in the color gamut of each of the monitors 15 (step S404). When the color gamut is included in the color gamut of each of the monitors 15 (YES in step S404), the target-property-value setting unit 134 sets, without performing any process, the target property value for the shape of the color gamut to be the target property value calculated in step S403 (step S405). In contrast, when, among the monitors 15, a monitor 15 having a color gamut that does not include the color gamut exists (NO in step S404), the target-property-value setting unit 134 sets a new target property value by changing the target property value calculated in step S403 (step S406).

Examples of a method for setting a new target property value include the following methods:

(i) a method in which weighted average calculation using an a*-value and a b*-value which have been set in step S403 and using the a*-values and the b*-values of each of the primary colors of the individual monitors 15 is performed;

(ii) a method in which the a*-value and the b*-value are changed from the a*-value and the b*-value which have been set in step S403 so that the saturation is made to the average of the values of the saturation of the individual monitors 15 while the hue is being maintained; and

(iii) a method in which appropriate values are selected from values that are within a range between the a*-value which has been set in step S403 and the average of the a*-values of the individual monitors 15 and that are within a range between the b*-value which has been set in step S403 and the average of the b*-values of the individual monitors 15.

Note that, in the present exemplary embodiment, the correction coefficient that is calculated by the correction-coefficient deriving unit 135 in step S105 is, for example, a color correction coefficient for an input image signal. More specifically, in the case where the shape of the color gamut is changed as in the present exemplary embodiment, the correction coefficient is, for example, a correction coefficient that is to be used to correct an a*-value and a b*-value or an X-value, a Y-value, and a Z-value.

Although, in the examples described above in detail, the first color-conversion profile that has been generated as described is used to perform color matching among the monitors 15, the usage of the first color-conversion profile is not limited thereto. For example, the method for generating the first color-conversion profile may be applied to an image forming device, such as a printer, that forms an image on a recording medium using an electrophotographic system or an inkjet system. In other words, it is supposed that color conversion is performed on an input image signal so that the input image signal is converted into a signal of a color space which is dependent on an image forming device, that the signal is output as an output image signal, and that the image forming device performs image formation using the output image signal. In such a case, for the image forming device, the color adjustment device 100 may be used in the color conversion that is performed on the input image signal. The color expressions of the monitors 15 and the color expression of the image forming device are easily made the same by using the color adjustment device 100.

Furthermore, although the color adjustment device 100 is provided so as to be built into each of the terminal apparatuses 10 in the examples described above in detail, the color adjustment device 100 may be separated from the terminal apparatus 10, and may be provided as a single device.

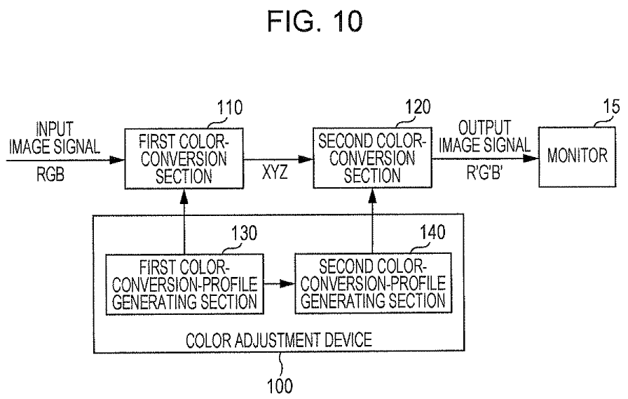

FIG. 10 is a diagram for explaining another example of the functional configuration of the color adjustment device in the present exemplary embodiment.

Regarding a color adjustment device 100 illustrated in FIG. 10, the first-color-conversion-profile generating section 130 and the second-color-conversion-profile generating section 140 are independent, and are included in the color adjustment device 100.

Note that, in the present exemplary embodiment, in the description given above, it is supposed that the monitors 15 from which the color-value obtaining unit 131 obtains color values and the monitors 15 for which color adjustment is performed are the same. However, the monitors 15 are not limited thereto. In other words, the first color-conversion profile is used to determine the definition of an input image signal as a new input image signal. As described above, an input image signal is converted by the first-color-conversion section 110 to obtain a signal, and the signal is utilized as a new input image signal, whereby substantially the same color expression can be realized for each of the monitors 15. For this reason, in order to generate the first color-conversion profile, the color properties of the monitors 15 from which color values are obtained are utilized. The first color-conversion profile may be applied to the case where color adjustment is performed for monitors 15 that are different from the monitors 15 from which color values have been obtained. As described above, the color conversion scheme in the present exemplary embodiment also has a feature that the color expressions of monitors 15 which are different from the monitors 15 from which color values have been obtained can be made substantially the same using the generated first color-conversion profile.

In this case, in the first-color-conversion-profile generating section 130 illustrated in FIG. 4, the color-value obtaining unit 131 obtains color values in the case where an image determined in advance is displayed on monitors 15 that are obtainment targets from which color values are obtained. Furthermore, the color-property-value deriving unit 132 derives, from the color values obtained by the color-value obtaining unit 131, values of color properties, which are determined in advance, of the monitors 15 that are obtainment targets. Furthermore, the correction-item selection unit 133 selects a color property as a common correction item from among the color properties on the basis of the values of the color properties derived by the color-property-value deriving unit 132. The common correction item is to be used to perform color adjustment for an image which is to be displayed on each of monitors 15 that are adjustment targets on which color adjustment is to be performed. Moreover, the target-property-value setting unit 134 sets, for the correction item selected by the correction-item selection unit 133, a target property value that is to be used as a common target in the case where color adjustment is performed for an image that is to be displayed on the monitors 15 that are adjustment targets and that is a value of the color property selected as the correction item. Additionally, the correction-coefficient deriving unit 135 derives a correction coefficient that is to be used to correct the values of the color property, which has been selected as the correction item, to the target property value which has been set by the target-property-value setting unit 134. Furthermore, the first-color-conversion-profile deriving unit 136 generates, on the basis of the correction coefficient derived by the correction-coefficient deriving unit 135, the common first color-conversion profile that is to be used to convert an input image signal in order to perform color adjustment for each of the monitors 15 that are adjustment targets.

Note that, in the present exemplary embodiment, it is necessary that the number of monitors 15 from which color values are obtained be two or more. However, the number of monitors 15 for which color adjustment is to be performed is not limited to two or more, and may be one.

Moreover, in the present exemplary embodiment, the black brightness is used as one of the various types of color properties that are used to perform color adjustment for the monitors 15. However, brightness (white brightness) in the case where a white image is displayed on the monitors 15 may be used instead of or together with the black brightness. In this case, a value of the white brightness an L*-value or a Y-value in the case where a white image is displayed on each of the monitors 15. A target property value for the white brightness may be derived using a method that is similar to the method used in the case of the black brightness.

Additionally, regarding processes that the color adjustment device 100 performs in the present exemplary embodiment, for example, the CPU 11 of each of the terminal apparatuses 10 loads various types of programs stored in the HDD 13 or the like into the main memory 12, and executes the various types programs, thereby performing the processes. In other words, in reality, color adjustment software executed in the terminal apparatus 10 performs the processes that the color adjustment device 100 performs.

Accordingly, the processes that the color adjustment device 100 performs may be considered as a program that causes a computer to realize the following functions: a function of obtaining color values in the case where an image determined in advance is displayed on monitors 15 that are obtainment targets which display images; a function of deriving, from the obtained color values, values of color properties, which are determined in advance, of the monitors 15 that are obtainment targets; a function of selecting a color property as a common correction item from among the color properties on the basis of the derived values of the color properties, the common correction item being an item that is to be used to perform color adjustment for an image which is be displayed on each of monitors 15 that are adjustment targets; a function of setting, for the selected correction item, a target property value that is to be used as a common target in the case where color adjustment is performed for an image which is to be displayed on each of the monitors 15 that are adjustment targets and that is a value of the color property selected as the correction item; a function of deriving a common correction coefficient that is to be used to correct the values of the color property, which has been selected as the correction item, to the target property value which has been set; and a function of generating, on the basis of the derived correction coefficient, the first color-conversion profile that is a color-adjustment profile which is to be used to convert an input image signal in order to perform color adjustment for an image that is to be displayed on each of the monitors 15 that are adjustment targets.

Note that the program which realizes the present exemplary embodiment may be provided by a communication medium. As a matter course, alternatively, the program may be stored on a recording medium such as a compact disc read-only memory (CD-ROM), and be provided.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A color adjustment device comprising:
a color-value obtaining unit that obtains color values in a case where an image which is determined in advance is displayed on image display devices that are obtainment targets which display images;
a color-property-value deriving unit that derives, from the color values obtained by the color-value obtaining unit, values of color properties of the image display devices that are obtainment targets, the color properties being properties associated with color expressions and determined in advance;
a correction-item selection unit that selects a color property as a common correction item from among the color properties on the basis of the values of the color properties derived by the color-property-value deriving unit, the correction item being an item that is to be used to perform color adjustment for an image which is to be displayed on an image display device that is an adjustment target;
a target-property-value setting unit that sets, for the correction item selected by the correction-item selection unit, a target property value which is to be used as a common target in the case where color adjustment is performed for an image that is to be displayed on the image display device that is an adjustment target and which is a value of the color property selected as the correction item;
a correction-coefficient deriving unit that derives a common correction coefficient which is to be used to correct the values of the color property selected as the correction item to the target property value that has been set by the target-property-value setting unit; and
a color-adjustment-profile generating unit that generates, on the basis of the correction coefficient derived by the correction-coefficient deriving unit, a color-adjustment profile which is to be used to convert an input image signal in order to perform color adjustment for an image which is to be displayed on the image display device that is an adjustment target.

2. The color adjustment device according to claim 1, further comprising a color conversion unit that converts, using the color adjustment profile generated by the color-adjustment-profile generating unit, the input image signal.

3. The color adjustment device according to claim 1, wherein the target-property-value setting unit sets, as the target property value, a value that is obtained by performing weighting in which frequencies of use of the image display devices that are obtainment targets are reflected.

4. The color adjustment device according to claim 2, wherein the target-property-value setting unit sets, as the target property value, a value that is obtained by performing weighting in which frequencies of use of the image display devices that are obtainment targets are reflected.

5. The color adjustment device according to claim 1, wherein the correction-item selection unit selects, as the correction item, at least one of brightness in a case where a black image is displayed on the image display devices that are obtainment targets, color temperature in a case where a white image is displayed on the image display devices that are obtainment targets, and the shape of a color gamut of each of the image display devices that are obtainment targets.

6. The color adjustment device according to claim 2, wherein the correction-item selection unit selects, as the correction item, at least one of brightness in a case where a black image is displayed on the image display devices that are obtainment targets, color temperature in a case where a white image is displayed on the image display devices that are obtainment targets, and the shape of a color gamut of each of the image display devices that are obtainment targets.

7. The color adjustment device according to claim 3, wherein the correction-item selection unit selects, as the correction item, at least one of brightness in a case where a black image is displayed on the image display devices that are obtainment targets, color temperature in a case where a white image is displayed on the image display devices that are obtainment targets, and the shape of a color gamut of each of the image display devices that are obtainment targets.

8. The color adjustment device according to claim 4, wherein the correction-item selection unit selects, as the correction item, at least one of brightness in a case where a black image is displayed on the image display devices that are obtainment targets, color temperature in a case where a white image is displayed on the image display devices that are obtainment targets, and the shape of a color gamut of each of the image display devices that are obtainment targets.

9. The color adjustment device according to claim 1, wherein the color-value obtaining unit obtains, as the color values in the case where an image determined in advance is displayed, color values in a case where a white image is displayed on the image display devices that are obtainment targets, color values in a case where a black image is displayed on the image display devices that are obtainment targets, and color values of primary colors in a case where the primary colors are displayed on the image display devices that are obtainment targets.

10. The color adjustment device according to claim 2, wherein the color-value obtaining unit obtains, as the color values in the case where an image determined in advance is displayed, color values in a case where a white image is displayed on the image display devices that are obtainment targets, color values in a case where a black image is displayed on the image display devices that are obtainment targets, and color values of primary colors in a case where the primary colors are displayed on the image display devices that are obtainment targets.

11. The color adjustment device according to claim 3, wherein the color-value obtaining unit obtains, as the color values in the case where an image determined in advance is displayed, color values in a case where a white image is displayed on the image display devices that are obtainment targets, color values in a case where a black image is displayed on the image display devices that are obtainment targets, and color values of primary colors in a case where the primary colors are displayed on the image display devices that are obtainment targets.

12. The color adjustment device according to claim 4, wherein the color-value obtaining unit obtains, as the color values in the case where an image determined in advance is displayed, color values in a case where a white image is displayed on the image display devices that are obtainment targets, color values in a case where a black image is displayed on the image display devices that are obtainment targets, and color values of primary colors in a case where the primary colors are displayed on the image display devices that are obtainment targets.

13. The color adjustment device according to claim 5, wherein the color-value obtaining unit obtains, as the color values in the case where an image determined in advance is displayed, color values in a case where a white image is displayed on the image display devices that are obtainment targets, color values in a case where a black image is displayed on the image display devices that are obtainment targets, and color values of primary colors in a case where the primary colors are displayed on the image display devices that are obtainment targets.

14. The color adjustment device according to claim 6, wherein the color-value obtaining unit obtains, as the color values in the case where an image determined in advance is displayed, color values in a case where a white image is displayed on the image display devices that are obtainment targets, color values in a case where a black image is displayed on the image display devices that are obtainment targets, and color values of primary colors in a case where the primary colors are displayed on the image display devices that are obtainment targets.

15. The color adjustment device according to claim 7, wherein the color-value obtaining unit obtains, as the color values in the case where an image determined in advance is displayed, color values in a case where a white image is displayed on the image display devices that are obtainment targets, color values in a case where a black image is displayed on the image display devices that are obtainment targets, and color values of primary colors in a case where the primary colors are displayed on the image display devices that are obtainment targets.

16. The color adjustment device according to claim 8, wherein the color-value obtaining unit obtains, as the color values in the case where an image determined in advance is displayed, color values in a case where a white image is displayed on the image display devices that are obtainment targets, color values in a case where a black image is displayed on the image display devices that are obtainment targets, and color values of primary colors in a case where the primary colors are displayed on the image display devices that are obtainment targets.

17. A color adjustment system comprising:
image display devices that are obtainment targets which display images;
a color-value obtaining unit that obtains color values in a case where an image which is determined in advance is displayed on the image display devices that are obtainment targets;
a color-property-value deriving unit that derives, from the color values obtained by the color-value obtaining unit, values of color properties of the image display devices that are obtainment targets, the color properties being properties associated with color expressions and determined in advance;
a correction-item selection unit that selects a color property as a common correction item from among the color properties on the basis of the values of the color properties derived by the color-property-value deriving unit, the correction item being an item that is to be used to perform color adjustment for an image which is to be displayed on an image display device that is an adjustment target;
a target-property-value setting unit that sets, for the correction item selected by the correction-item selection unit, a target property value which is to be used as a common target in the case where color adjustment is performed for an image that is to be displayed on the image display device that is an adjustment target and which is a value of the color property selected as the correction item;
a correction-coefficient deriving unit that derives a common correction coefficient which is to be used to correct the values of the color property selected as the correction item to the target property value that has been set by the target-property-value setting unit; and
a color-adjustment-profile generating unit that generates, on the basis of the correction coefficient derived by the correction-coefficient deriving unit, a color-adjustment profile which is to be used to convert an input image signal in order to perform color adjustment for an image which is to be displayed on the image display device that is an adjustment target.

18. A color adjustment method comprising:
obtaining color values in a case where an image which is determined in advance is displayed on image display devices that are obtainment targets which display images;
deriving, from the obtained color values, values of color properties of the image display devices that are obtainment targets, the color properties being properties associated with color expressions and determined in advance;
selecting a color property as a common correction item from among the color properties on the basis of the derived values of the color properties, the correction item being an item that is to be used to perform color adjustment for an image which is to be displayed on an image display device that is an adjustment target;
setting, for the selected correction item, a target property value which is to be used as a common target in a case where color adjustment is performed for an image that is to be displayed on the image display device that is an adjustment target and which is a value of the color property selected as the correction item;
deriving a common correction coefficient which is to be used to correct the values of the color property selected as the correction item to the target property value that has been set; and
generating, on the basis of the derived correction coefficient, a color-adjustment profile which is to be used to convert an input image signal in order to perform color adjustment for an image which is to be displayed on the image display device that is an adjustment target.

19. A non-transitory computer-readable medium storing a program causing a computer to execute a process, the process comprising:
obtaining color values in a case where an image which is determined in advance is displayed on image display devices that are obtainment targets which display images;
deriving, from the obtained color values, values of color properties of the image display devices that are obtainment targets, the color properties being properties associated with color expressions and determined in advance;
selecting a color property as a common correction item from among the color properties on the basis of the derived values of the color properties, the correction item being an item that is to be used to perform color adjustment for an image which is to be displayed on an image display device that is an adjustment target;
setting, for the selected correction item, a target property value which is to be used as a common target in a case where color adjustment is performed for an image that is to be displayed on the image display device that is an adjustment target and which is a value of the color property selected as the correction item;
deriving a common correction coefficient which is to be used to correct the values of the color property selected as the correction item to the target property value that has been set; and
generating, on the basis of the derived correction coefficient, a color-adjustment profile which is to be used to convert an input image signal in order to perform color adjustment for an image which is to be displayed on the image display device that is an adjustment target.
